(19) United States
(12) Patent Application Publication
(10) Pub. No.: US 2015/0369648 A1
(43) Pub. Date: Dec. 24, 2015

(54) FLUID LEVEL SENSOR

(71) Applicant: Medallion Instrumentation Systems, LLC, Spring Lake, MI (US)

(72) Inventors: Richard P. Bertalan, Norton Shores, MI (US); Ronald B. Peel, Whitehall, MI (US); Scott R. Zuidema, Grand Haven, MI (US)

(21) Appl. No.: 14/747,279

(22) Filed: Jun. 23, 2015

Related U.S. Application Data
(60) Provisional application No. 62/015,672, filed on Jun. 23, 2014.

(51) Int. Cl. G01F 23/36; B60K 15/03; G01F 23/38

(52) U.S. Cl. CPC G01F 23/36; G01F 23/38; B60K 15/03; B60K 2015/03217

(57) ABSTRACT

A fluid level detector having a sensor and a sensor object carried by a rotatable carrier. The sensor may or may not be sealed within a housing, and may provide an output signal based on a sensed characteristic of the sensor object, where the sensed characteristic may be different depending on the position of the sensor object relative to the sensor.

### TECHNICAL FIELD

The present invention relates to a fluid level sensor, and more particularly to an inductive type fluid level sensor.

### BACKGROUND

Fluid level sensors are used in a variety of applications to detect a level of fluid within a container. One application of growing significance is in the field of fuel senders for fuel tanks in vehicles. In such an application, a fuel sender including a fluid level sensor is often times disposed within a container, such as a fuel tank, and may include a float that rises and falls along with the fuel level in the container. The float may be rotatably coupled to the fuel sender via a float arm whose angular position corresponds to the float position and therefore the fluid level in the container. In other words, the angular position of the float arm depends on the fluid level in the container. The fuel sender may use this relationship between angular position and fuel level as a basis for determining the fuel level, and providing a corresponding output indicative of the determined fuel level, such as an output having resistance in the range of 240-30 ohms. In one example, the fuel sender may be disposed within the container such that the float arm rotates from a full fuel tank to an empty field tank. As fuel is consumed from the fuel tank by the vehicle engine, the fuel level as well as the float falls, and therefore the angular position of the float arm changes. The fuel sender may include a sensor capable of providing an output related to the angular position of the float arm, and therefore related to the fuel level. This output may be provide to components of the vehicle, such as a fuel gauge.

One conventional sensor used in such a fuel sender is a rheostat having a wiper and a resistive ink disposed on a ceramic substrate that forms a variable resistor or potentiometer. The wiper in this construction is in electrical contact with and moves along the resistant ink of the ceramic substrate. The float and the float arm may be connected to the wiper so that the resistance of the rheostat varies as the angular position of the float and float arm change. This type of resistive sensor is not without drawbacks, particularly when used in fuel level applications. In many cases, the resistive ink or wiper, or both, wear over time affecting the reliability and accuracy of the fuel sender. Repeated mechanical movement of the wiper on the resistive ink tends to change the physical properties of these components over time, potentially leading to inaccuracy and failure. Another factor that can affect accuracy and reliability of rheostats, when used in fuel applications, is oxidation caused by moisture in the fuel.

Due at least in part to these drawbacks, there have been efforts in recent times to move away from the rheostat based fuel sender. Some effort has been devoted to developing inductive coil and bobbin configurations for use in fuel senders as an alternative to the rheostat. In the conventional inductive coil and bobbin configuration, the fuel sender includes an inductive coil mounted in a fixed position, similar to the resistive ink in the rheostat configuration. The bobbin, like the wiper, is connected to the float and the float arm, and moves within the inductive coil. The bobbin in this configuration slides or moves within the inductive coil, affecting the effective inductance. The positional relationship of the bobbin relative to the inductive coil is related to their effective inductance. Therefore, with the float arm and the float being connected to the bobbin, the effective inductance of the inductive coil and the bobbin relates to the angular position of the float and flow arm. In this way, the fuel sender may determine a fuel level based on the effective inductance of the bobbin and the inductive coil. This configuration, however, is also not without drawbacks. The bobbin and the inductive coil, themselves, are coils of wire, the manufacture of which can increase cost over the rheostat construction. Additionally, because the freedom of movement of the bobbin is limited by the length of the bobbin and the inductive coil, the inductive coil and bobbin in the conventional construction is configured to operate over a fixed range of movement. Additionally, in this conventional configuration, both the inductive coil and the bobbin are directly exposed to the fuel.

### SUMMARY OF THE INVENTION

The present invention provides a fluid level detector having a sensor and a sensor object carried by a rotatable carrier. The sensor may or may not be sealed within a housing, and may provide an output signal based on a sensed characteristic of the sensor object, where the sensed characteristic may be different depending on the position of the sensor object relative to the sensor. The sensor object may rotate with the carrier, and may be constructed such that a physical property of the sensor object, such as width or cross-sectional area, is variable along a dimension of the sensor object. The physical property may affect the sensed characteristic such that, for different positions of the sensor object relative to the sensor, the sensed characteristic may be different. For example, as the sensor object rotates relative to the sensor, the sensed characteristic may change as a function of a change in the physical property of the sensor object.

In one embodiment, the sensor is disposed on or within a sensor support, and the carrier is rotatably mounted to a carrier mount of the sensor support. A portion of the sensor object may rotate in an arc about the carrier mount, where the arc defines a portion of a perimeter boundary of a bounded plane, such as a circular plane. The sensor in this embodiment is disposed outside the bounded plane. As an example, the sensor may be outside the bounded plane, and may intersect a plane parallel to the circular plane. As another example, the sensor may be outside the bounded plane, but may intersect an unbounded plane defined by the bounded plane.

In another embodiment, the carrier of the fluid level detector may be coupled to a float and a float arm, both of which are capable of being disposed within a fluid container. The float and the float arm may rotate the carrier, including the sensor object, relative to the sensor. The float may rise and fall with the fluid in the fluid container, translating a fluid level in the container to an angular position of both the float arm and the carrier. Each of the carrier, the float, and the float arm may be separate components coupled together during manufacture. Alternatively, one or more of the carrier, the float, and the float arm may be integrated in a single component. For example, the float and float arm may be an integrated component separate from the carrier but coupled thereto during manufacture. As another example, all three of the carrier, the float, and the float arm may be an integrated component.

In yet another embodiment, the sensor object of the fluid detector may rotate freely relative to the sensor, and without physical contact with the sensor. The rotational range of movement of the sensor object is not tied to or dependent on the physical construction of the sensor and the sensor object. As a result, the same fluid detector construction may be implemented in different applications irrespective of the fluid container configuration and the amount of rotation of a float arm between full and empty fluid levels.

In one aspect, a fluid detector may include a rotatable carrier coupled to a float, and capable of rotating freely without being impeded by a sensor. Construction of a fluid detector according to one embodiment may avoid hand assembly other than the float arm, or avoid wipers, or both. The sensor may be completely sealed within the sensor housing such that there are no external wires or traces potentially exposed to fluid in the fluid container.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a front perspective view of a fluid level detector according to one embodiment;

FIG. 2 is a top view of the fluid level detector;

FIG. 3 is a front view of the fluid level detector within a fluid container;

FIG. 4 is a rear perspective view of the fluid detector;

FIG. 5 is a sectional view of the fluid level detector depicted in FIG. 2;

FIG. 6 is a sectional view of the fluid level detector depicted in FIG. 2;

FIG. 7 is an exploded view of the fluid level detector;

FIG. 8 is another front perspective view of the fluid detector;

FIG. 9 is a front view of a sensor object and a sensor of the fluid level detector;

FIG. 10 is a perspective view of the sensor object and the sensor of the fluid level detector;

FIG. 11 is a perspective view of a one-piece float and float arm according to one embodiment; and

FIG. 12 is a perspective view of a one-piece float and float arm according to one embodiment.

FIG. 13 is a front view of a sensor of a fluid level detector according to one embodiment.

FIG. 14 is a front view of a sensor object of the fluid level detector according to one embodiment.

### DETAILED DESCRIPTION

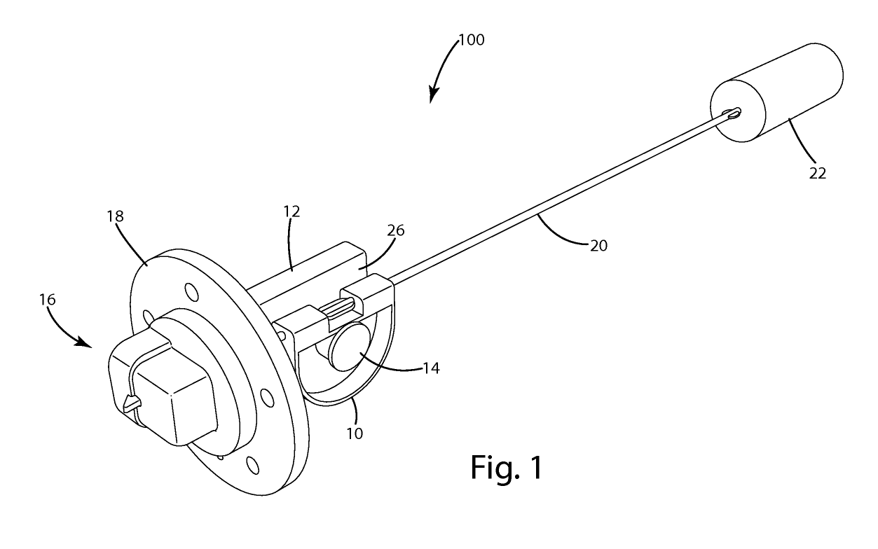

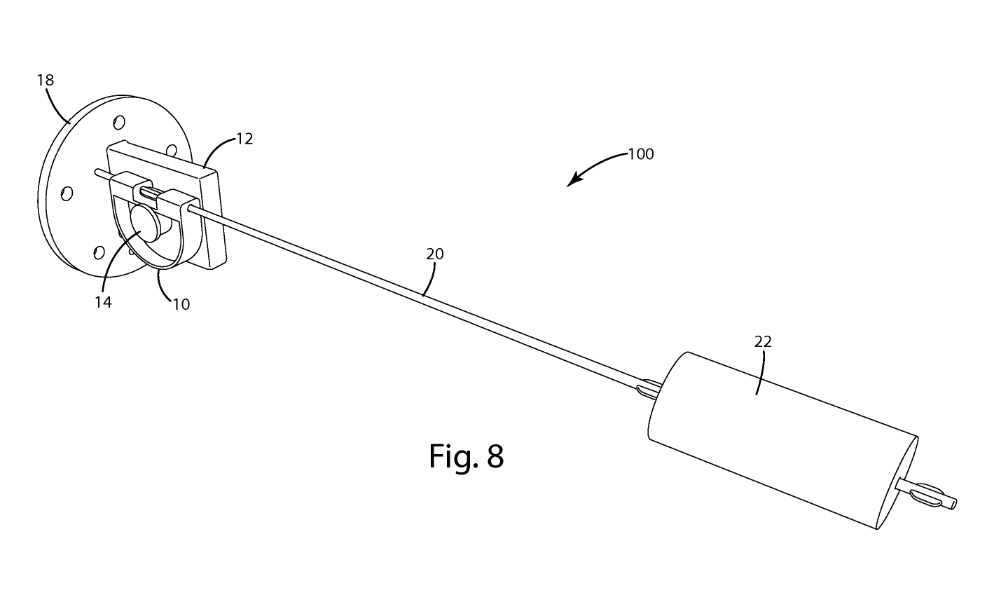

A fluid level detector in accordance with one or more embodiments of the present invention is shown in FIGS. 1-10, and generally designated 100. As set forth below, the fluid level detector 100 may include a sensor object 30 carried by a rotatable carrier 10. The rotatable carrier 10 may be coupled to a float 22 configured to rotate the rotatable carrier 10. As the float 22 rises and falls with fluid 110 in a fluid container 112, the rotatable carrier 10 may rotate accordingly. In this way, a fluid level of the fluid 110 in the fluid container 112 may correspond to an angular position of the rotatable carrier 10. An output of the fluid level detector 100 may be dependent on the position of the sensor object 30 of the rotatable carrier 10 relative to a sensor 32, and therefore may be indicative of the fluid level within the fluid container 112.

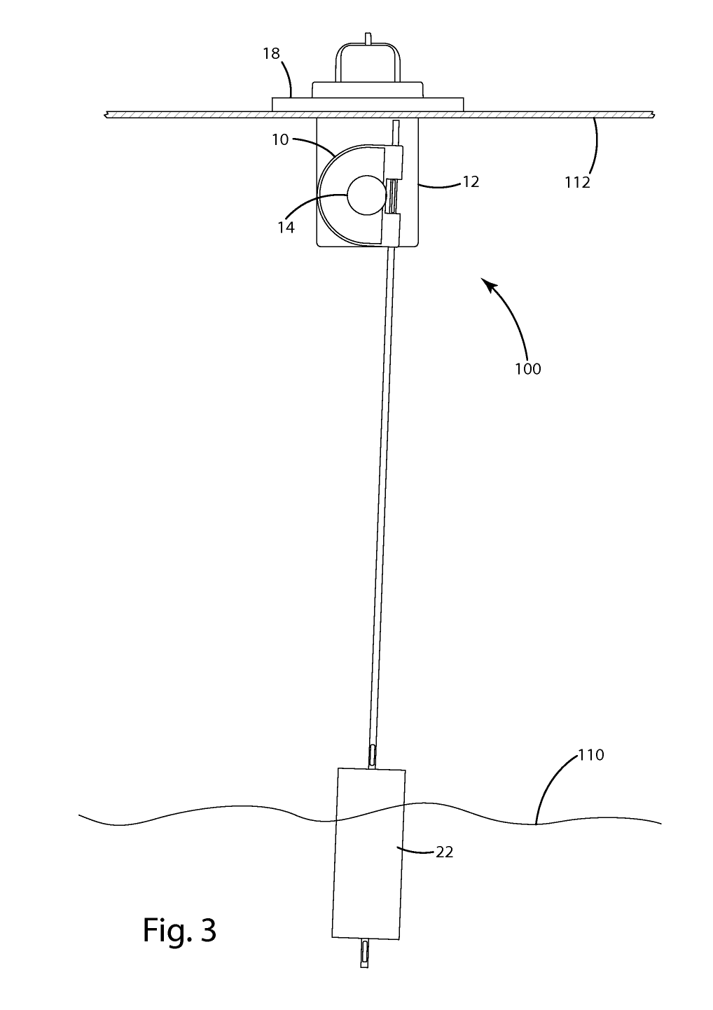

In the illustrated embodiments of FIGS. 1-10, the fluid level detector 100 includes a container mount 18, an electrical connector 16, and a carrier support 12. The container mount 18 may include a flange that supports part of the fluid level detector 100 within the fluid container 112, as shown in FIG. 3, so that the electrical connector 16 or electrical contacts 17 of the electrical connector 16, or both, remain accessible to a wiring harness (not shown) external to the fluid container 112. The wiring harness may include a corresponding connector (not shown) that mates to the electrical connector 16. The wiring harness may form part of a vehicle wiring system, and may communicate an output signal from the electrical connector 16 to a fuel gauge or a vehicle processor. The container mount 18 may further include one or more mounting holes that allow fasteners, such as screws or rivets, to affix the container mount 18 to the container 112. To potentially prevent leakage from the container 112, a seal, such as a solvent resistant gasket, may be disposed between the container mount 18 and the container 112.

The carrier support 12 may support the rotatable carrier 10, the float arm 20 and the float 22 within the fluid container 112, and may extend into the fluid container 112 from a portion of the fluid level detector 100 proximate to the container mount 18. The extent to which the carrier support 12 extends into the container 112 may depend on a variety of factors, including, for example, the desired placement and configuration of the rotatable carrier 10, the float arm 20, and the float 22. The configuration of the rotatable carrier 10, the float arm 20, and the float 22 may depend on factors, such as the physical size and shape of the container 112. For instance, if the fluid container 112 is relatively narrow with little room for a long float arm, the carrier support 12 may extend further into the container 112 so that the fuel detector 100 may utilize a shorter float arm that rotates more than 90° from an empty condition to a full condition in the container.

As depicted in FIG. 6, the carrier support 12 may support a sensor 32 and sensor circuitry 24. In the illustrated embodiment, the sensor 32 and the sensor circuitry 24 may be sealed within the carrier support 12 to prevent contact with the fluid 110 within the fluid container 112. The carrier support 12, as well as the container mount 18, may be formed of plastic (e.g., a fuel resistant plastic) in an injection molding process. All or portions of the sensor 32, sensor circuitry 24, and the electrical contacts 17 may be overmolded in the injection molding process in order to achieve a physical configuration in which the sensor 32, sensor circuitry 24 and the electrical contacts 17 are substantially prevented from contacting the fluid 110 in use. For example, the sensor 32 and the sensor circuitry 24 may be completely sealed within a portion of the carrier support 12 that extends into the fuel container 112. The electrical contacts 17 may provide an external interface to the sensor circuitry 24. In an alternative embodiment, the carrier support 12 may be comprised of multiple pieces, which may be joined together to form the carrier support 12, and to substantially prevent the sensor 32 and sensor circuitry 24 from contacting the fluid 110 in use. It should be understood that any type of joining technique may be used, including for example ultrasonic welding.

The carrier support 12 may include a carrier mount 15 that rotatably supports the carrier 10. In the illustrated embodiment, the carrier mount 15 is a cylindrical projection extending from a carrier face 24 of the carrier support 12, and is receivable by an aperture 11 of the carrier 10. An end of the carrier mount 15 distal from the carrier face 24 of the carrier support 12 may interface with a retainer 14 that retains the carrier 10 on the carrier mount 15 of the carrier support 12. In this way, the carrier 10 may rotate about the carrier mount 15 and relative to the carrier support 12 without falling off the carrier mount 15. It should be understood that one or more embodiments described herein are not limited to this configuration, and that the carrier 10 may be rotatably coupled to a carrier support 12 in a variety of ways.

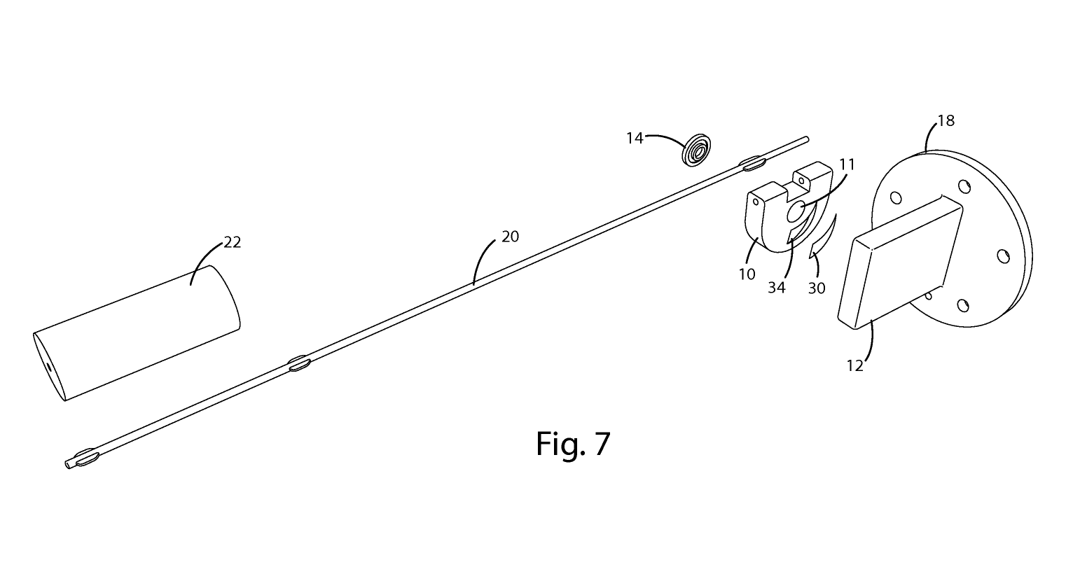

As shown in the illustrated embodiment of FIG. 7, the carrier 10 may be coupled to the float arm 20 and the float 22, and may carry a sensor object 30. As will be described below, the sensor object 30 of the carrier 10 may be constructed such that a physical property of the sensor object 30, e.g., width or cross-sectional area, may vary. This variable property of the sensor object 30 may affect a characteristic sensed by the sensor 32 of the fluid detector 100 differently depending on the relative position of the sensor object 30 of the sensor 32.

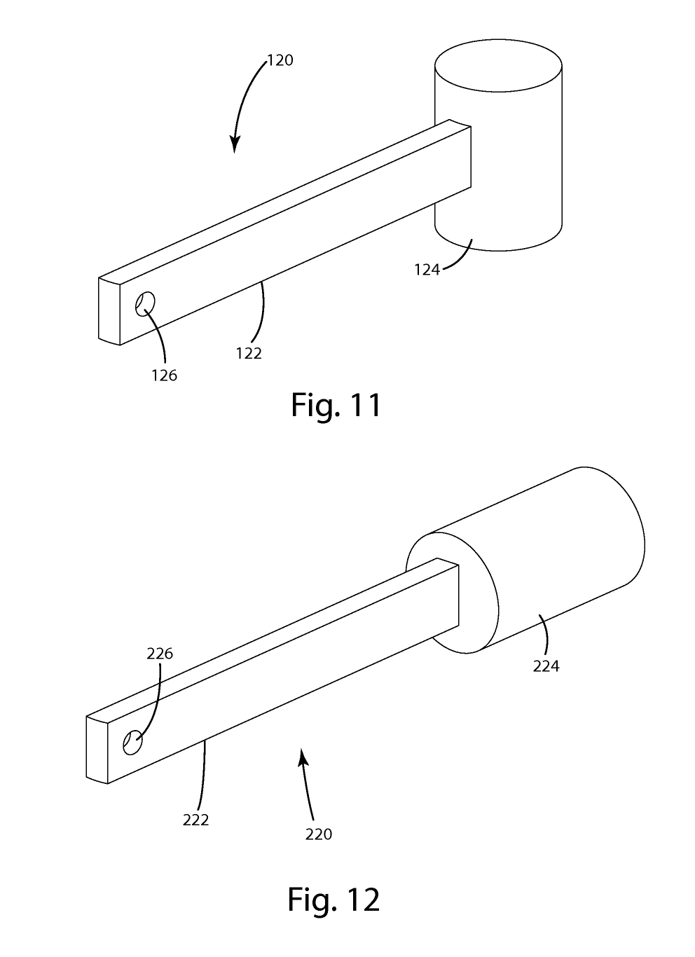

In the illustrated embodiment of FIG. 7, the float arm 20 is depicted as a rod receivable by apertures of the carrier 10 and by apertures of the float 22. The float arm 20 may be crimped during manufacture at one or more locations proximate to the apertures of the carrier 10 and the float 22 so that the float arm 20 is prevented from substantially sliding through the apertures after being received by the apertures. In this way, the float arm 20 may couple the carrier 10 and the float 22. It should be understood that embodiments described herein are not limited to this construction, and that the carrier 10 may be coupled to a float 22 in a variety of ways, such as the alternative embodiment depicted in FIG. 11.

The float 22 in the illustrated embodiment of FIG. 7 may float proximate to a surface of the fluid 110 within the fluid container 112. Because the float 22 is coupled to the carrier 10, and because the float 22 floats on the surface of the fluid 110, the float 22 rotates the carrier 10 to an angular position corresponding to a particular fluid level within the fluid container 112. By sensing a characteristic indicative of the angular position of the carrier 10, a fluid level within the fluid container 112 may be determined. In particular, the angular position of the carrier 10 may correspond to an angular position of the sensor object 30 relative to the sensor 32 supported by the carrier support 12. The sensor object 30 may affect a characteristic sensed by the sensor 32, such as effective inductance, differently depending on the angular position of the sensor object 30. Based on the characteristic sensed by the sensor 32, the sensing circuitry 24 may determine a fluid level within the fluid container 112, and provide a corresponding output via the electrical connector 16. The output may be a resistance variable over a range corresponding to a predetermined standard, such as a range of 240-33 ohms, where 240 ohms represents an empty container, and 33 ohms represents a full container. It should be understood that the output may be different, and that the fuel detector 100 may provide any output indicative of a fuel level. Additional examples include a pulse width modulated output whose duty cycle is indicative of a fuel level.

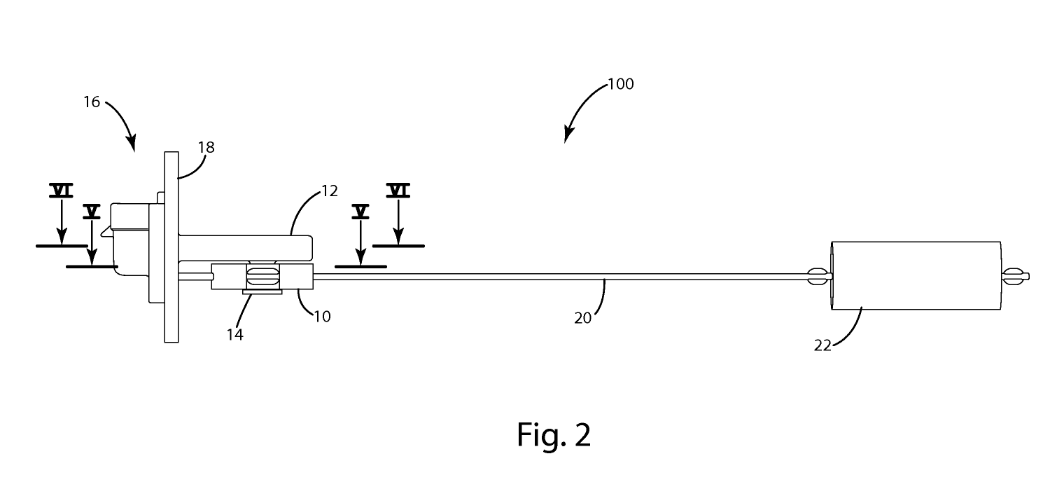

Turning to the illustrated embodiments of FIGS. 2, 5-6 and 9-10, the sensor object 30 carried by the carrier 10, the sensor 32, and the sensor circuitry 24 will now be described in further detail. As depicted in FIGS. 2, 5-6, and 10, the sensor 32 may be disposed such that a profile 33 of the sensor object 30 moves relative to the sensor 32 in response to rotation of the carrier 10 about the carrier mount 15. The amount of metal or mass of metal in proximity to the sensor 32 may vary as the sensor object 30 moves. Such variations may be achieved in a variety of ways. In one embodiment, the size and shape of the sensor object 30 may vary along the profile 33. Additionally or alternatively, at least one of size, shape, and placement of the sensor 32 may be constructed such that, as the sensor object 30 moves, an amount of overlap or a degree of proximity between the sensor 32 and the sensor object 30 changes.

In one embodiment, a physical property of the sensor object 30, such as its width or cross-sectional area, may be variable along the profile 33. This variance in the physical property along the profile 33 may affect a characteristic sensed by the sensor 32 differently depending on the relative position between the sensor 32 and the sensor object 30. In an alternative embodiment, the width or cross-sectional area of the sensor object 30 may be generally uniform, and the sensor 32 may be sized and positioned such that a characteristic sensed by the sensor 32 is dependent on the relative position between the sensor 32 and the sensor object 30.

The sensor object 30 may be any type of material capable of affecting a characteristic sensed by the sensor 32, including, for example, a ferrous metal such as stainless steel. The carrier 10 may a plastic, such as a fuel resistance plastic, and may be affixed to the sensor object 30 in any number of ways, including molding, adhering, or riveting, or a combination thereof.

The sensor 32 may be any type of sensor capable of sensing a variance in a physical property of the sensor object 30. However, for purposes of disclosure, the sensor 32 is described in connection with an inductive proximity sensor capable of providing an output indicative of an effective inductance sensed in proximity to the sensor 32. The sensor 32 may include an inductor, and the sensor circuitry 24 may include an oscillator that drives the inductor with an oscillation signal by the oscillator. The inductor may be a coil of wire or a trace printed on the printed circuit board 24. The sensor circuitry 24 may also include a detector coupled to the inductor and capable of detecting changes in the oscillation signal caused by the inductor. These changes may be indicative of an effective inductance in proximity to the inductor. As an example, the effective inductance of the inductor may change depending on the presence of metal in proximity thereto. If the amount or mass of metal in proximity to the inductor changes, the effective inductance of the inductor sensed by the detector may also change. Using this relationship of effective inductance and presence of metal, the sensor 32 and sensor circuitry 24 may correlate the sensed effective inductance to a fluid level of the fluid container 112, and provide an output indicative of the fluid level.

Although components of the sensor 32 and sensor circuitry 24 are depicted separately, it should be understood that the sensor 32 and sensor circuitry 24 may be integrated. For example, the sensor 32 and the sensor circuitry 24 may be printed circuitry disposed on a substrate, such as FR4. It should also be understood that one or more components of the sensor 32 and sensor circuitry 24 may be positioned differently, including, for example, the sensor 32 being positioned as depicted in phantom lines in FIG. 10.

As mentioned above, a physical property of the sensor object 30 may be variable along the profile 33 of the sensor object 30. The illustrated embodiment of FIGS. 2, 5 and 9-10 depicts the cross-sectional area of the sensor object 30 decreasing from a first end 50 of the sensor object 30 to a second end 52. In other words, the cross-sectional area of the sensor object 30 may taper from one end 50 to the other end 52. In the illustrated embodiment, the sensor object 30 is curved such that, as the carrier 10 rotates, the profile 33 of the sensor object 30 may remain in proximity to the sensor 32. Because the cross-sectional area of the sensor object 30 tapers, the amount of mass of the sensor element 30 in proximity to the sensor 32 may vary depending on the angular position of the carrier 10, affecting the effective inductance of the inductor of the sensor 32. As an example, in an embodiment in which the sensor object 30 is metal, the amount of metal in proximity to the sensor 32 may be different depending on the angular position of the sensor object 30 relative to the sensor 32, affecting effective inductance of the sensor 32 in a way that changes depending on the angular position.

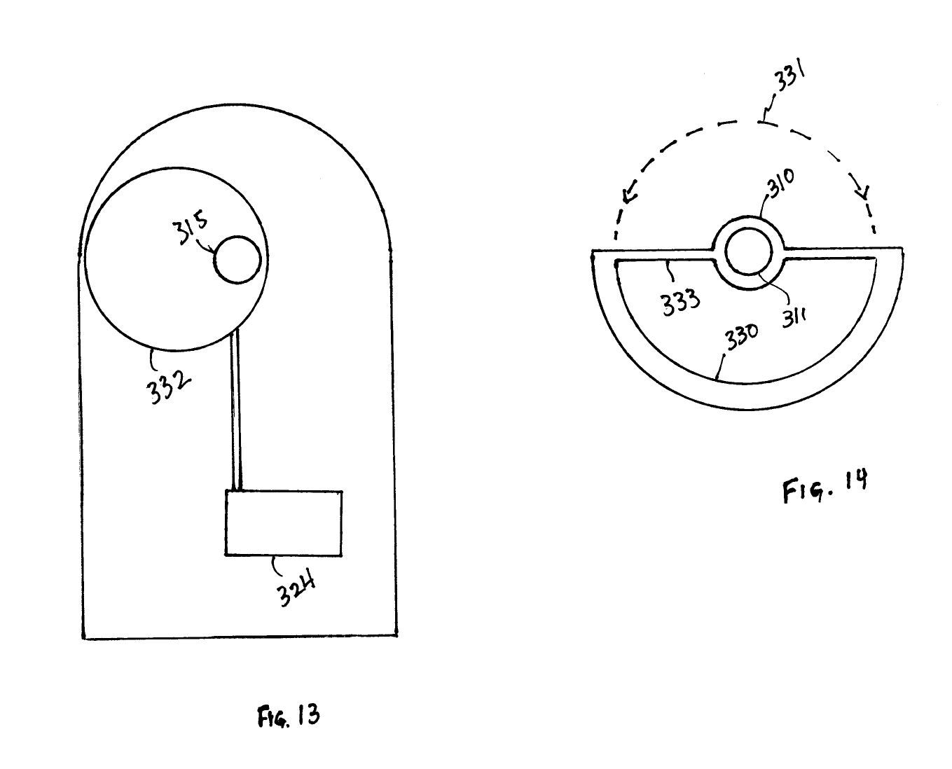

An alternative embodiment of the sensor object and sensor are shown in FIGS. 13 and 14, and generally designated 330 and 332 respectively. The sensor object 330 may be carried by a carrier 310, similar to the carrier 10 described herein. A portion of the sensor object 330 or a motion path of the sensor object 330 may define a bounded plane 331 (shown in part in phantom), similar to the bounded plane 31. Further, the sensor 332 may be coupled to sensor circuitry 324, similar to sensor circuitry 24 described herein. The sensor object 330 may be generally uniform in shape or constructed such that one or more physical properties of the sensor object 330 are substantially the same along a profile 333 of the sensor object 330. The illustrated embodiment of FIGS. 13 and 14 depict the cross-sectional area of the sensor object 330 being substantially the same along the profile 333. In the illustrated embodiment, the sensor 332 may be a coil of wire sized and positioned such that rotation of the sensor object 330 relative to the sensor 332 about a carrier aperture 315 of the carrier 310 or a carrier mount 315 may result in variation in the amount of overlap between the sensor object 330 and the sensor 332. Depending on the degree of rotation, the amount of mass of the sensor object 330 that overlaps the sensor 332 may vary. In this way, an effective inductance sensed by the sensor 332 may substantially correspond to the degree of rotation of the sensor object 330 relative to the sensor 332.

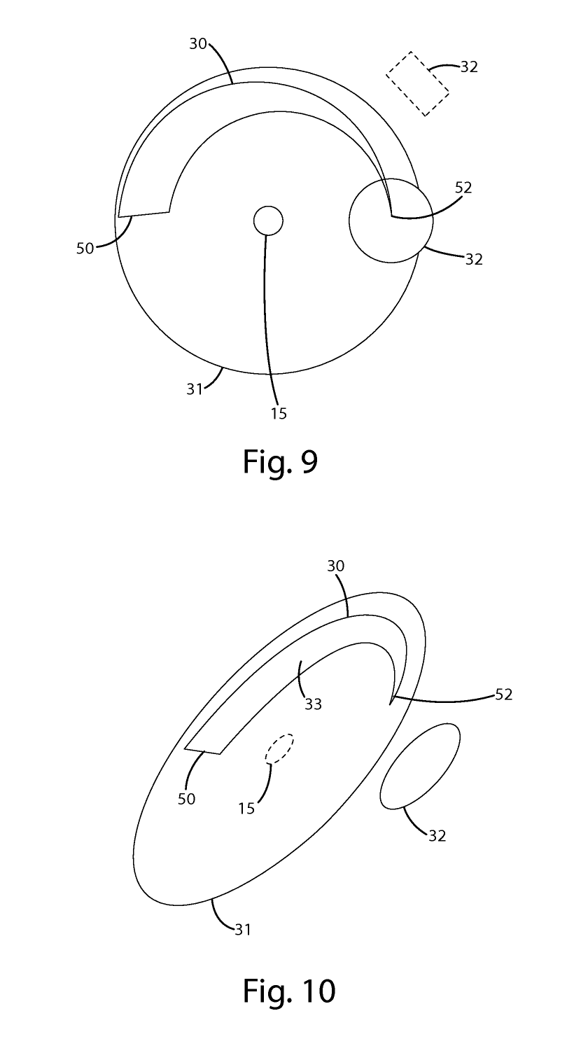

In the illustrated embodiment of FIG. 14, the sensor 332 includes a coil that is generally offset relative to the carrier mount 315. In other words, an axis of the coil of the sensor 332 may be out of alignment with an axis associated with the carrier mount 315, similar to the sensor 32 in the illustrated embodiment of FIG. 9. In this way, a position of the sensor 332 may be asymmetric relative to an motion path of the sensor object 330 or a range over which the sensor object 330 can move. This asymmetry may allow the effective inductance of the sensor 332 to vary based on the position of the sensor object 332 within the motion path. It should be understood that any of the embodiments described herein in connection with the sensor 32 and sensor object 30 may utilize one or more components or arrangements described or shown in connection with the illustrated embodiments of FIGS. 13 and 14.

Based on the effective inductance sensed by the inductor, the sensor 32 and the sensor circuitry 24 may determine the angular position of the carrier 10, and use this information as a basis for determining a fluid level of the container 112. As an example, the sensor circuitry 24 may include processing circuitry (not shown) configured to translate an effective inductance sensed by the sensor 32 to a fluid level. Because the relationship between a fluid level and the angular position of the carrier 10 may be dependent on a variety of factors, including the fluid container 112 configuration and the length of the float arm 20, the processing circuitry may be provided with configuration parameters during manufacture to associate the fluid detector 100 with the fluid container 112, and to enable appropriate translation between effective inductance and fluid level. The fluid detector 100 may be calibrated during manufacture in a calibration mode by rotating the carrier 10 from minimum to maximum positions, corresponding primarily to a particular tank configuration's empty/full conditions, and obtaining and storing calibration factor measurements. The fluid detector 100 may be provided tank information indicative of the geometry of the fluid container 112 to enable the fluid detector 100 to provide an appropriate fluid level output based on the calibration factor measurements and the tank information. Put differently, the fluid detector 100 may rescale measurements obtained from the sensor 32 based on the calibration factor measurements and the tank information.

Additionally or alternatively, the fluid detector 100 may be configurable in the field using one or more external selector switches (not shown), or based on communication received from a vehicle system via the connector 16. In this alternative embodiment, the same fluid detector 100 may be utilized in a variety of applications without making specific modifications during manufacture to configure the fluid detector 100 for each application.

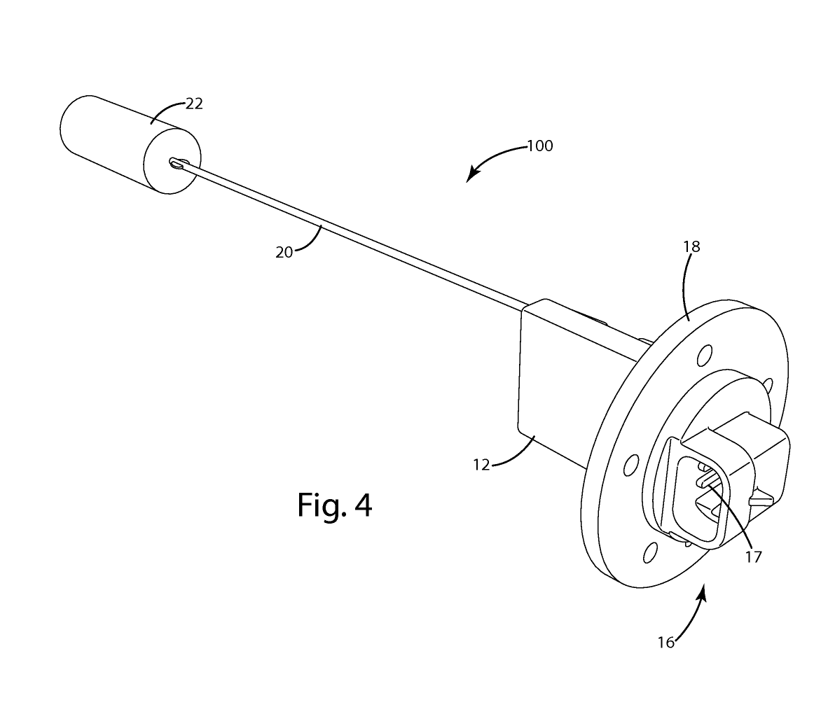

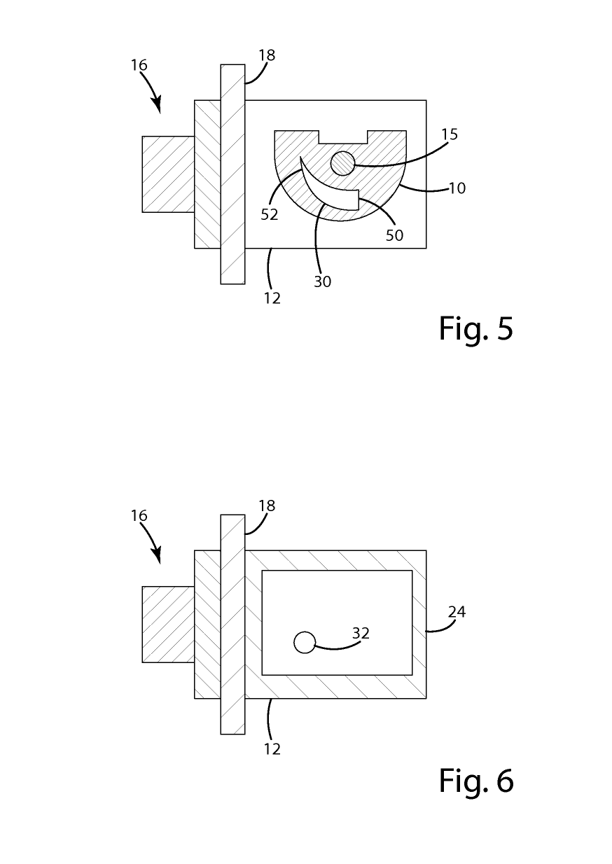

In the illustrated embodiment of FIGS. 5-6 and 9-10, the sensor object 30 is substantially flat such that the variance in the cross-sectional area from the first end 50 to the second end 52 primarily appears as a taper in the width of the profile 33 of the sensor 32 from the first end 50 to the second end 52. The profile 33 in this configuration appears fang-shaped. It should be understood, however, that the sensor object 30 or sensor 32, or both, may be configured differently, and that embodiments described herein may be configured with any type of sensor object 30 or sensor 32, or both, that affects a sensed parameter of the sensor 32, such as effective inductance, differently depending on an angular position of the sensor object 30 relative to the sensor 32. For example, in the illustrated embodiments of FIGS. 13 and 14, the relative position between the sensor object 330 and the sensor 332 may result in a different effective inductance. As the sensor object 330 rotates with the carrier 310, the amount of overlap between the sensor 332 and the sensor object 330 can change, thereby affecting the effective inductance of the sensor 332. Although one or more embodiments of the present disclosure are described in connection with changes in effective inductance, it should be understood that any parameter of the sensor 332 may be sensed. As an example, an impedance of the sensor 332 at one or more frequencies may vary in dependence on the relative position between the sensor 332 and the sensor object 330. The impedance can be monitored and used as a basis for determining the relative position. By disposing the sensor object 30 on or within the carrier 10 according to one embodiment, the carrier 10 and sensor object 30 may rotate freely irrespective of the position of the sensor 32 and without being impeded by the sensor 32. As shown in the illustrated embodiment of FIGS. 9-10, the sensor 32 may be disposed outside a bounded plane defined by (a) a portion of the sensor object 30 and (b) rotation of the carrier 10 along with the sensor object 30. More specifically, with the sensor object 30 being carried by the carrier 10 in a rotatable manner about the carrier mount 15, a portion of the sensor object 30, such as the end 50, may travel along a path that defines a portion of a perimeter boundary of a bounded plane 31. In operation, the fluid detector 100, including the carrier 10, may be configured to enable the sensor object 30 to travel along some or all of the perimeter boundary of the bounded plane 31. As an example, the path traveled by a portion of the sensor object 30 in rotating about the carrier mount 15 may be an arc that defines a substantially circular bounded plane. It should be understood that the bounded plane 31 may be defined by substantially any path that a portion of the sensor object 30 travels in rotating about the carrier mount 15. As an example, rather than being a substantially circular path, the path may be elliptical, and therefore the bounded plane 31 may be elliptical.

In the illustrated embodiment, the bounded plane 31 is approximately 50 mm in diameter, but it should be understood that the present disclosure is not so limited. The bounded plane 31 may be any size or shape, or both.

As mentioned above, the sensor 32 may be disposed outside the bounded plane 31 whose boundary is based on all or a portion of a path traversed by a portion of the sensor object 30. In this way, the sensor 32 may be positioned such that it does not restrict movement of the sensor object 30. In the illustrated embodiments of FIGS. 9-10, the sensor 32, or a portion thereof, is positioned such that it intersects a plane parallel to the bounded plane 31. The sensor 32 may also be positioned such that it is outside the bounded plane 31 but intersects an unbounded plane defined by the bounded plane 31. The bounded plane 31 may be considered a portion of the unbounded plane, thereby defining the unbounded plane. This optional positioning of the sensor 32 is depicted in the illustrated embodiment of FIG. 9 in phantom line.

In an alternative embodiment, shown in FIG. 11, the float arm 20 and float 22 may be formed of an integrated component, referred to as a one-piece float 120. The one-piece float 120 may include an arm portion 122 and a head portion 124. The one-piece float 120 can be manufactured in bulk, and adapted for particular configurations by, for example, cutting the arm portion 122 to a length desired for a particular tank configuration. The one-piece float 120 may include an opening 126, capable of enabling coupling to the carrier 10. One or more openings may be positioned along the length of the arm portion 122, enabling the arm portion 122 to be cut to size while still providing an opening for coupling to the carrier 10. All or portions of the one-piece float 120 may be formed of closed cell, molded plastic. For example, the head portion 124 may be closed cell, and the arm portion may be solid or open cell.

The one-piece float 120 may be formed using a single-stage or multi-stage molding process. For example, the arm portion 122 and the head portion 124 may be formed of the same material, and may be injection molded in a single-shot process or single-stage molding process. As another example, the arm portion 122 and the head portion 124 may be produced of different materials, molded together in a multi-stage process. As depicted in the illustrated embodiment of FIG. 11, the head portion 124 is larger in diameter than the arm portion 122, and extends in two directions away from a longitudinal axis of the arm portion 122. However, it should be understood that the head portion 124 may be configured different, and that any type of configuration may be used, including for example, different sizes, shapes, and relative sizing to the arm portion 122.

In the illustrated embodiment of FIG. 12, the one-piece float 220 is similar to the one-piece float 120 but with several exceptions. The one-piece float 220 includes an opening 226 and arm portion 222, similar to the opening 126 and arm portion 122. The head portion 224 of the one-piece float 220 extends along a longitudinal axis of the arm portion 122, and, like the head portion 124, may be larger in diameter than the arm portion 222.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A fluid sensor configured to provide a signal indicative of a fluid level of fluid in a fluid container, said fluid sensor comprising:
a carrier support having a carrier mount;
a carrier rotatably mounted to said carrier mount of said carrier support, wherein a portion of said carrier rotates in a path about said carrier mount, wherein said path defines a portion of a perimeter boundary of a bounded plane;
a sensor object carried by said carrier;
a sensor configured to sense a characteristic affected by said sensor object, wherein said sensor is positioned outside said bounded plane, wherein, based on said sensed characteristic, said sensor provides said signal indicative of the fluid level.

2. The fluid sensor of claim 1 wherein said path is an arc about said carrier mount, wherein said bounded plane is a circular plane, and wherein said arc defines a portion of said perimeter boundary of said circular plane.

3. The fluid sensor of claim 2 wherein said sensor intersects a plane parallel to said circular plane.

4. The fluid sensor of claim 1 wherein said sensor intersects an unbounded plane defined by said bounded plane.

5. The fluid sensor of claim 1 wherein said sensor object has a physical property that varies along a dimension of said sensor object.

6. The fluid sensor of claim 5 wherein said sensor object is metal, and wherein said physical property is a cross-sectional area of said sensor object, wherein said sensor object tapers from a first end to a second end such that said cross-sectional area of said sensor object decreases from said first end to said second end, and such that a profile of said sensor object facing said sensor decreases in width from said first end to said second end.

7. The fluid sensor of claim 6 wherein said sensed characteristic is an effective inductance of said sensor, wherein said effective inductance of said sensor varies as said profile of said sensor object moves relative to said sensor.

8. The fluid sensor of claim 1 further comprising a float and a float arm, said float arm coupling said float to said carrier, wherein said float is configured to float in proximity to a surface of the fluid in the fluid container.

9. The fluid sensor of claim 8 wherein said float and said float arm form a one-piece float.

10. The fluid sensor of claim 1 wherein said sensor is sealed within said carrier support such that said sensor is substantially prevented from being exposed to the fluid.

11. A fluid sensor configured to provide a signal indicative of a fluid level of a fluid container, said fluid sensor comprising:
a carrier support having a carrier mount;
a carrier rotatably mounted to said carrier mount of said carrier support, wherein a portion of said carrier rotates in a path about said carrier mount, wherein said path defines a portion of a perimeter boundary of a bounded plane;
a sensor object carried by said carrier;
a sensor configured to sense a characteristic affected by said physical property of said sensor object, wherein said sensor is sealed within said carrier mount such that said sensor is substantially prevented from being exposed to the fluid, wherein, based on said sensed characteristic, said sensor provides said signal indicative of the fluid level.

12. The fluid sensor of claim 11 wherein said path is an arc about said carrier mount, wherein said bounded plane is a circular plane, and wherein said arc defines a portion of said perimeter boundary of said circular plane.

13. The fluid sensor of claim 11 wherein said sensor is positioned outside said bounded plane.

14. The fluid sensor of claim 13 wherein said sensor intersects a plane parallel to said circular plane.

15. The fluid sensor of claim 13 wherein said sensor intersects an unbounded plane defined by said bounded plane.

16. The fluid sensor of claim 11 wherein said sensor object has a physical property that varies along a dimension of said sensor object.

17. The fluid sensor of claim 16 wherein said sensor object is metal, and wherein said physical property is a cross-sectional area of said sensor object, wherein said sensor object tapers from a first end to a second end such that said cross-sectional area of said sensor object decreases from said first end to said second end, and such that a profile of said sensor object facing said sensor decreases in width from said first end to said second end.

18. A method of detecting a fluid level of fluid within a container comprising:
providing a carrier support having a carrier mount and a carrier rotatably mounted to the carrier mount, wherein a portion of the carrier rotates in a path about the carrier mount, wherein the path defines a portion of a perimeter boundary of a bounded plane;
sensing a characteristic of a sensor affected by a physical property of the carrier, wherein the sensor is positioned outside the bounded plane; and
based on the sensed characteristic, generating a signal indicative of the fluid level.

19. The method of claim 18 wherein the path is an arc about the carrier mount, wherein the bounded plane is a circular plane, and wherein the arc defines a portion of the perimeter boundary of the circular plane.

20. The method of claim 18 wherein the sensed characteristic is an effective inductance of the sensor, wherein the carrier includes a sensor object that affects the effective inductance depending the angular position of the carrier relative to the sensor.

21. The method of claim 18 further comprising calibrating sensor based on container configuration parameters.

22. The method of claim 18 where the physical property of the carrier varies over a dimension of the carrier.
